(19) United States
(12) Patent Application Publication
(10) Pub. No.: US 2026/0057015 A1
(43) Pub. Date: Feb. 26, 2026

(54) METHOD AND SYSTEM FOR MANAGING AND UPDATING DATA OFFERINGS IN A DATA PLATFORM

(71) Applicant: JPMorgan Chase Bank, N.A., New York, NY (US)

(72) Inventor: Arthur G. LYNCH, Hamilton (GB)

(73) Assignee: JPMorgan Chase Bank, N.A., New York, NY (US)

(21) Appl. No.: 19/304,188

(22) Filed: Aug. 19, 2025

Related U.S. Application Data
(60) Provisional application No. 63/685,560, filed on Aug. 21, 2024.

(51) Int. Cl. G06F 16/904

(52) U.S. Cl. CPC G06F 16/904

(57) ABSTRACT

A method and a system for managing data offerings are provided. The method includes: receiving a first data offering that is in a first administrative state that is only viewable to a data owner of the first data offering; analyzing a series of rules relating to at least one data property of the first data offering; determining, based on a result of the analyzing of the series of rules, a current status of the first data offering; shifting the first data offering from being in the first administrative state to a second administrative state based on whether the current status is in a predetermined status; receiving, via the user interface, a first request to publish the first data offering; and publishing, in response to the first request and the first data offering being in the second administrative state, the first data offering.

### CROSS-REFERENCE TO RELATED APPLICATIONS

This application claims priority benefit from U.S. Provisional Application No. 63/685,560, filed on Aug. 21, 2024, in the U.S. Patent and Trademark Office, which is hereby incorporated by reference in its entirety.

### FIELD OF THE DISCLOSURE

This technology generally relates to methods and systems for managing data offerings, and more particularly to methods and systems for accepting and maintaining content in a data platform to improve transitions to updated data content.

### BACKGROUND INFORMATION

Data platforms and/or marketplaces rely on technical and business metadata to be seamlessly blended to give a rich user experience to data consumers. However, this metadata typically originates from multiple sources and poses a challenge to version management of data offering content since one system could regress the changes applied from another. Data consumers (e.g., data scientists and data analysts) need frictionless access to strategic data assets, including detailed attribute descriptions for each data offering data dictionary, as well as support links, contact details and entitlements needed for access.

In conventional data platforms and systems, all materials created in the data marketplace are created as drafts (i.e., a single version of that document). If a change needs to be made, the document must be re-drafted. However, this creates potential issues when there are multiple collaborators/authors trying to edit the document, causing them to have to edit the document externally before publishing the draft. Additionally, in these conventional systems, there may also be many different data distribution types (e.g., Python, Snowflake, etc.), which creates an issue for doing a draft as the metadata may be different for each different data distribution type.

Accordingly, there is a need for methods and systems capable of accepting and maintaining content in a data platform to improve transitions to updated data content.

### SUMMARY

The present disclosure, through one or more of its various aspects, embodiments, and/or specific features or sub-components, provides, inter alia, various systems, servers, devices, methods, media, programs, and platforms for accepting and maintaining content in a data platform to improve transitions to updated data content. According to an aspect of the present disclosure, a method for managing data offerings is provided. The method may be implemented by at least one processor. The method may include: receiving, by the at least one processor via at least one from among a user interface and an automated feed to a system interface, a first data offering that is in a first administrative state that is only viewable to a data owner of the first data offering; analyzing, by the at least one processor, a series of rules relating to at least one data property of the first data offering; determining, by the at least one processor based on a result of the analyzing of the series of rules, a current status of the first data offering; shifting, by the at least one processor, the first data offering from being in the first administrative state to a second administrative state based on whether the current status is in a predetermined status; receiving, by the at least one processor via the user interface, a first request to publish the first data offering; and publishing, by the at least one processor in response to the first request and the first data offering being in the second administrative state, the first data offering.

The first data offering may include at least one data set that is accessible via at least one data platform from among a plurality of data platforms.

The at least one data property may include at least one from among a name of the first data offering, a purpose of the first data offering, a line of business of the first data offering, access rights of the first data offering, and a data dictionary of attributes for the first data offering.

The method may further include: receiving, by the at least one processor via at least one from among the user interface and the automated feed to the system interface, an updated version of the first data offering that is in the first administrative state and an active registration state; analyzing, by the at least one processor, the series of rules relating to the at least one data property of the updated version of the first data offering; determining, by the at least one processor based on a result of the analyzing of the series of rules for the updated version of the first data offering, a current status of the updated version of the first data offering; shifting, by the at least one processor, the updated version of the first data offering from being in the first administrative state to the second administrative state based on whether the current status of the updated version of the first data offering is in the predetermined status; receiving, by the at least one processor via the user interface, a second request to publish the updated version of the first data offering; and publishing, by the at least one processor in response to the second request and the updated version of the first data offering being in the second administrative state and the active registration state, the updated version of the first data offering.

The first data offering may be in the second administrative state while the updated version of the first data offering is in the first administrative state.

The user interface may include a filtering tool that allows a user to filter differences between the first data offering and the updated version of the first data offering.

The first data offering may be maintained by at least one API that distributes the first data offering using at least one data distribution service from among a plurality of data distribution services.

The first data offering may include at least one field name that is mappable to a logical data dictionary to be recognizable across the plurality of data distribution services.

The user interface may generate notifications that are transmitted to the data owner when at least one change is made to the first data offering.

According to another aspect of the present disclosure, a computing apparatus for querying database data using natural language is provided. The computing apparatus may include a processor; a memory; and a communication interface coupled to each of the processor and the memory. The processor may be configured to: receive, via at least one from among a user interface and an automated feed to a system interface, a first data offering, wherein the first data offering is in a first administrative state that is only viewable to a data owner of the first data offering; analyze a series of rules relating to at least one data property of the first data offering; determine, based on a result of the analysis, a current status of the first data offering; shift the first data offering from being in the first administrative state to a second administrative state based on whether the current status is in a predetermined status; receive, via the user interface, a first request to publish the first data offering; and in response to the first request and the first data offering being in the second administrative state, publish the first data offering.

The first data offering may include at least one data set that is accessible via at least one data platform from among a plurality of data platforms.

The at least one data property may include at least one from among a name of the first data offering, a purpose of the first data offering, a line of business of the first data offering, access rights of the first data offering, and a data dictionary of attributes for the first data offering.

The processor may be further configured to: receive, via at least one from among the user interface and the automated feed to the system interface, an updated version of the first data offering, wherein the updated version of the first data offering is in the first administrative state and an active registration state; analyze the series of rules relating to the at least one data property of the updated version of the first data offering; determine, based on a result of the analyzing of the series of rules for the updated version of the first data offering, a current status of the updated version of the first data offering; shift the updated version of the first data offering from being in the first administrative state to the second administrative state based on whether the current status of the updated version of the first data offering is in the predetermined status; receive, via the user interface, a second request to publish the updated version of the first data offering; and in response to the second request and the updated version of the first data offering being in the second administrative state and the active registration state, publish the updated version of the first data offering.

The first data offering may be in the second administrative state while the updated version of the first data offering is in the first administrative state.

The user interface may include a filtering tool that allows a user to filter differences between the first data offering and the updated version of the first data offering.

The first data offering may be maintained by at least one application programming interface (API) that distributes the first data offering using at least one data distribution service from among a plurality of data distribution services.

The first data offering may include at least one field name that is mappable to a logical data dictionary to be recognizable across the plurality of data distribution services.

The user interface may generate notifications that are transmitted to the data owner when at least one change is made to the first data offering.

According to yet another aspect of the present disclosure, a non-transitory computer readable storage medium storing instructions for managing data offerings is provided. The storage medium includes executable code which, when executed by a processor, may cause the processor to: receive, via at least one from among a user interface and an automated feed to a system interface, a first data offering, wherein the first data offering is in a first administrative state that is only viewable to a data owner of the first data offering; analyze a series of rules relating to at least one data property of the first data offering; determine, based on a result of the analysis, a current status of the first data offering; shift the first data offering from being in the first administrative state to a second administrative state based on whether the current status is in a predetermined status; receive, via the user interface, a first request to publish the first data offering; and in response to the first request and the first data offering being in the second administrative state, publish the first data offering.

The first data offering may include at least one data set that is accessible via at least one data platform from among a plurality of data platforms.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for accepting and maintaining content in a data platform to improve transitions to updated data content, according to an embodiment.

FIG. 2 illustrates a diagram of a network environment for accepting and maintaining content in a data platform to improve transitions to updated data content, according to an embodiment.

FIG. 3 illustrates a system diagram of a system for accepting and maintaining content in a data platform to improve transitions to updated data content, according to an embodiment.

FIG. 4 illustrates a process diagram of a process for accepting and maintaining content in a data platform to improve transitions to updated data content, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units, and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or similar, they may be programmed using software (e.g., microcode) to perform various functions discussed herein and may optionally be driven by firmware and/or software. Alternatively, each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of the example embodiments may be physically separated into two or more interacting and discrete blocks, units, and/or modules without departing from the scope of the inventive concepts. Further, the blocks, units and/or modules of the example embodiments may be physically combined into more complex blocks, units, and/or modules without departing from the scope of the present disclosure.

A system or method disclosed herein first receives a data set or data offering that is in a first administrative state, such that it is only viewable to the data owners associated with that data set. The system analyzes the first data set with respect to a set or series of rules that relate to the properties or conditions of the data set. Based on the results of the analysis, the system determines the current status of the data set (e.g., the system may determine that the data set is in an active registration state). Next, when the system determines that the data set is in a predetermined state or meets a certain condition, the system changes the data set from being in the first administrative state to being in a second administrative state. The system may then receive a request from a user interface to publish the data set, and then, based on that request and the data set being in the second administrative state, the system publishes the data set so that it is accessible to users beyond just the data owners associated with the data set.

This system and method provide multiple advantages over existing technology. For example, the system provides data consumers (e.g., data scientists and data analysts) frictionless access to strategic data assets, including detailed attribute descriptions for each data offering data dictionary, as well as support links, contact details and entitlements needed for access. Moreover, this system enables data owner's workflow to be presented with a simpler derived state on both coarse and fine-grained properties. Additionally, these states provide visual cues such as differential highlighting that facilitate the review, editing, and management of the data being uploaded. Furthermore, this system enables automation to incrementally adopt and perform all the model transformation necessary to convert raw metadata to marketplace data offerings, increasing speed and efficiency, and reducing the required resources for managing and accessing data. Also, because the system allows for the management of data sets for various schema and data services, the system improves network and computing efficiency by reducing the number of third-party systems and communications with unintegrated systems by seamlessly integrating data publication for a variety of resources, systems, and services.

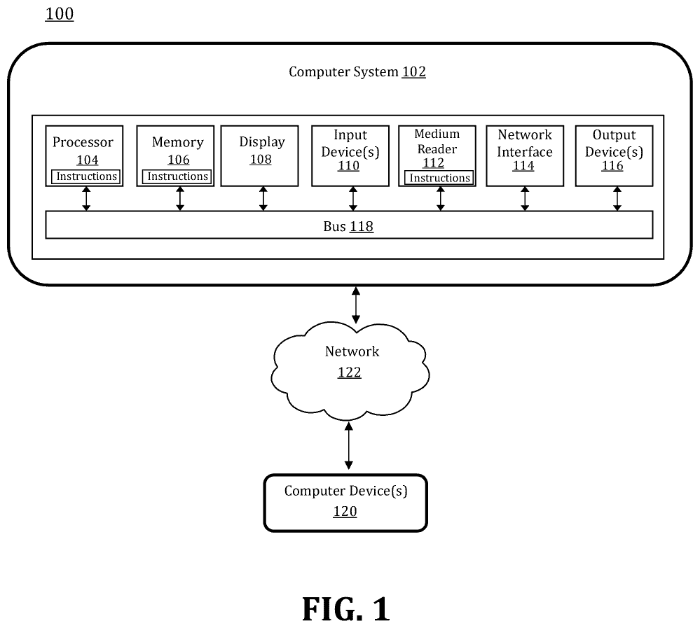

FIG. 1 is a system 100 for accepting and maintaining content in a data platform to improve transitions to updated data content in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In an embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, and serial advanced technology attachment.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the data offering management module implemented by the system 100 may allow for accepting and maintaining content in a data platform to improve transitions to updated data content. The configuration or data files, in some embodiments, may be written using JavaScript Object Notation (JSON), but the disclosure is not limited thereto. For example, the configuration or data files may easily be extended to other readable file formats such as Extensible Markup Language (XML), Yet Another Markup Language (YAML), or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionalities as described herein, and a processor described herein may be used to support a virtual processing environment.

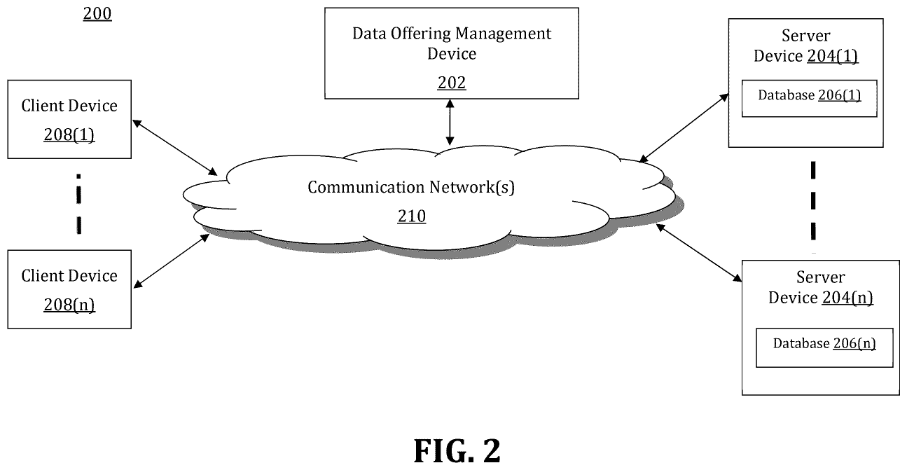

Referring to FIG. 2, a schematic of a network environment 200 for accepting and maintaining content in a data platform to improve transitions to updated data content is illustrated.

In some embodiments, the above-described problems associated with conventional tools may be overcome by implementing a data offering management device 202 as illustrated in FIG. 2 that may be configured for accepting and maintaining content in a data platform to improve transitions to updated data content, but the disclosure is not limited thereto.

The data offering management device 202 may include one or more computer systems 102, as described with respect to FIG. 1, which in aggregate provide the necessary functions.

The data offering management device 202 may store one or more applications that can include executable instructions that, when executed by the data offering management device 202, cause the data offering management device 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the data offering management device 202 itself, may be located in virtual server(s) running in a cloud-based computing environment rather than being tied to one or more specific physical network computing devices. Also, the application(s) may be running in one or more virtual machines (VMs) executing on the data offering management device 202. Additionally, in one or more embodiments of this technology, virtual machine(s) running on the data offering management device 202 may be managed or supervised by a hypervisor.

In the network environment 200 of FIG. 2, the data offering management device 202 may be coupled to a plurality of server devices 204(1)-204(n) that hosts a plurality of databases 206(1)-206(n), and also to a plurality of client devices 208(1)-208(n) via communication network(s) 210. A communication interface of the data offering management device 202, such as the network interface 114 of the computer system 102 of FIG. 1, operatively couples and communicates between the data offering management device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the data offering management device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use Transmission Control Protocol/Internet Protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The data offering management device 202 may be a standalone device or integrated with one or more other devices or apparatuses, such as one or more of the server devices 204(1)-204(n), for example. In one example, the data offering management device 202 may be hosted by one of the server devices 204(1)-204(n), and other arrangements are also possible. Moreover, one or more of the devices of the data offering management device 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the data offering management device 202 via the communication network(s) 210 according to the Hypertext Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) host databases 206(1)-206(n) that are configured to store data sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the data offering management device 202 that may efficiently provide a platform for accepting and maintaining content in a data platform to improve transitions to updated data content, but the disclosure is not limited thereto.

The client devices 208(1)-208(n) may run interface applications, such as standard web browsers or standalone client applications, which may provide an interface to communicate with the data offering management device 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the data offering management device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the data offering management device 202, the server devices 204(1)-204(n), or the client devices 208(1)-208(n), for example, may be configured to operate as virtual instances on the same physical machine. For example, one or more of the data offering management devices 202, the server devices 204(1)-204(n), or the client devices 208(1)-208(n) may operate on the same physical device rather than as separate devices communicating through communication network(s) 210. Additionally, there may be more or fewer data offering management devices 202, server devices 204(1)-204(n), or client devices 208(1)-208(n) than illustrated in FIG. 2. In some embodiments, the data offering management device 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

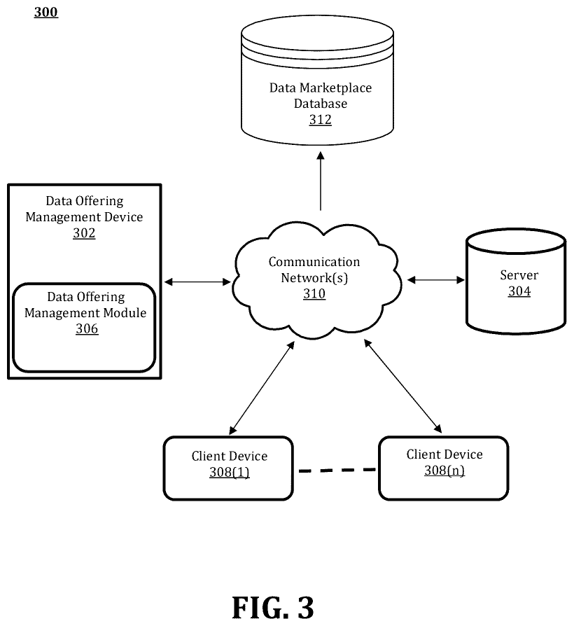

FIG. 3 illustrates a system diagram for accepting and maintaining content in a data platform to improve transitions to updated data content in accordance with an embodiment.

As illustrated in FIG. 3, the system 300 may include a data offering management device 302 within which a data offering management module 306 is embedded, a server 304, a data marketplace database 312, a plurality of client devices 308(1) . . . 308(n), and a communication network 310.

In some embodiments, the data offering management device 302 including the data offering management module 306 may be connected to the server 304, and the data marketplace database(s) 312 via the communication network 310. The data offering management device 302 may also be connected to the plurality of client devices 308(1) . . . 308(n) via the communication network 310, but the disclosure is not limited thereto. The data marketplace database 312 may include one or more repositories or databases.

In an embodiment, the data offering management device 302 is described and shown in FIG. 3 as including the data offering management module 306, although it may include other rules, policies, modules, databases, or applications, for example. In some embodiments, the data marketplace database 312 may be configured to store ready to use modules written for each API for all environments. Although only one database is illustrated in FIG. 3, the disclosure is not limited thereto. Any number of desired databases may be utilized for use in the disclosed invention herein. The data marketplace database(s) 312 may be a mainframe database, a log database that may produce programming for searching, monitoring, and analyzing machine-generated data via a web interface, but the disclosure is not limited thereto. In addition, the data marketplace database 312 may store a plurality of data sets and/or data offerings.

In some embodiments, the data offering management module 306 may be configured to receive real-time feed of data from the plurality of client devices 308(1) . . . 308(n) and secondary sources via the communication network 310.

The data offering management module 306 may be configured to: receive, via a user interface, a first data offering that is in a first administrative state that is only viewable to a data owner of the first data offering; analyze a series of rules relating to at least one data property of the first data offering; determine, based on a result of the analyzing of the series of rules, a current state of the first data offering; shift the first data offering from being in the first administrative state to a second administrative state based on whether the current state is in a predetermined state; receive, via the user interface, a first request to publish the first data offering; and publish, in response to the first request and the first data offering being in the second administrative state, the first data offering.

The plurality of client devices 308(1) . . . 308(n) are illustrated as being in communication with the data offering management device 302. In this regard, the plurality of client devices 308(1) . . . 308(n) may be “clients” (e.g., customers) of the data offering management device 302 and are described herein as such. Nevertheless, it is to be known and understood that the plurality of client devices 308(1) . . . 308(n) need not necessarily be “clients” of the data offering management device 302, or any entity described in association therewith herein. Any additional or alternative relationship may exist between either or both plurality of client devices 308(1) . . . 308(n) and the data offering management device 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the pluralities of client devices 308(1) . . . 308(n) may communicate with the data offering management device 302 via broadband or cellular communication. Of course, these embodiments are merely exemplary and are not limiting or exhaustive.

The client devices 308(1)-308(n) may be the same or similar to any one of the client devices 208(1)-208(n) as described with respect to FIG. 2, including any features or combination of features described with respect thereto. The data offering management device 302 may be the same or similar to the data offering management device 202 as described with respect to FIG. 2, including any features or combination of features described with respect thereto.

Upon being started, the data offering management device 302 executes a process for accepting and maintaining content in a data platform to improve transitions to updated data content.

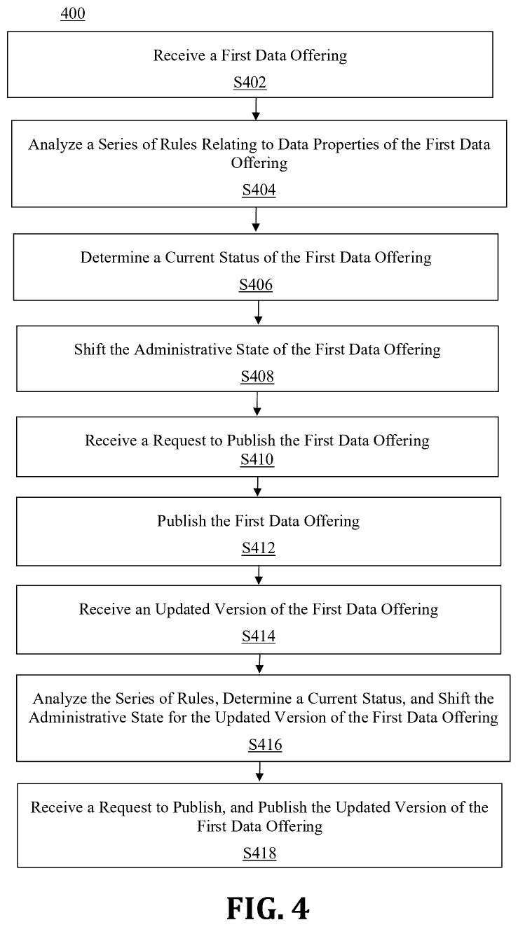

Referring to FIG. 4, a process 400 for accepting and maintaining content in a data platform to improve transitions to updated data content is illustrated, according to an embodiment.

In process 400 of FIG. 4, at step S402, the data offering management device 302 may receive a first data offering. In some embodiments, the first data offering may be transmitted and received by a user interface. In an embodiment, the first data offering may be transmitted and received by an automated feed that transmits data to a system interface. The first data offering may be generated and transmitted to the data offering management device by at least one data owner. The first data offering may be at least one data set that is used by data consumers (e.g., data scientists and/or data analysts) for a variety of uses (e.g., asset management). In an embodiment, when the first data offering is received by the data offering management device 302, it may be in a first administrative state that is only viewable to the at least one data owner. The first data offering may be accessible with different operational systems or applications (e.g., Excel). In an embodiment, the first data offering may include at least one data set that is accessible by multiple different data platforms. In some embodiments, the first data offering may be maintained by at least one API that may distribute the first data offering using a variety of different data distribution services (e.g., Python, Snowflake, etc.). In an embodiment, the first data offering may include at least one field name that may be mapped to a logical data dictionary so that it may be recognized across a variety of different data distribution services.

At step S404, the data offering management device 302 may analyze a series of rules relating to data properties of the first data offering. In an embodiment, the at least one data property may include at least one from among a name of the first data offering, a purpose of the first data offering, a line of business of the first data offering, access rights of the first data offering, and a data dictionary of attributes for the first data offering. In some embodiments, the series of rules may relate to a series of API properties that may be managed by the API.

At step S406, the data offering management device 302 may determine a current status or state of the first data offering. In an embodiment, the determined current status of the first data offering may relate to a status state of each data property based on the analyzing of the series of rules. For example, when received, the first data offering may be in an active registration state and a first or pending administrative state.

At step S408, the data offering management device 302 may shift the first data offering from being in the first administrative state to a second administrative state based on the current status. In some embodiments, the first administrative state may be shifted to the second administrative state when the current status is in an approved and ready status state. In an embodiment, the first data offering may be determined to be in the approved and ready status state when each rule of the series of rules is satisfied and has been approved.

At step S410, the data offering management device 302 may receive a request to publish the first data offering. In an embodiment, the request may be transmitted and received by the user interface. The data owner may make the request.

At step S412, the data offering management device 302 may publish the first data offering. In an embodiment, the published first data offering may be viewable to consumers (e.g., data scientists and/or data analysts). In some embodiments, the first data offering may be published within a data marketplace and/or data platform. In an embodiment, the first data offering may be publishable when the administrative state is in the second or approved state and the registration state is in the active state.

At step S414, the data offering management device 302 may receive an updated version of the first data offering. In some embodiments, the updated version of the first data offering may be any change, update, addition, and/or deletion to the first data offering. In an embodiment, updated versions of the first data offering may be transmitted and received by the user interface. In an embodiment, the updated version of the data offering may be transmitted and received by an automated feed that transmits data to a system interface. The automated feed may be part of software development lifecycle events that may be automatically captured by the API of the data management device 302. In some embodiments, the data management device 302 may receive updates from both the user interface and the automated feed to create a multi-master aspect to the data management device 302. The updated version of the first data offering may be generated and transmitted to the data offering management device by at least one data owner. In an embodiment, when the updated version of the first data offering is received by the data offering management device 302, it may be in a first administrative state that is only viewable to the at least one data owner. In some embodiments, the first data offering may be in the second administrative state and viewable by consumers, while the updated version of the first data offering is in the first administrative state and viewable only by the at least one data owner. The updated version of the first data offering may be accessible with different operational systems or applications (e.g., Excel). In some embodiments, the updated version of the first data offering may be maintained by at least one API that may distribute the first data offering using a variety of different data distribution services (e.g., Python, Snowflake, etc.). In an embodiment, the updated version of the first data offering may have the same properties and characteristics as the first data offering. In an embodiment, the user interface may generate notifications that are transmitted to the at least one data owner when a change and/or update is made to the first data offering. In some embodiments, the user interface may include a filtering tool that allows a user to filter differences between the first data offering and the updated first data offering.

At step S416, the data offering management device 302 may analyze the series of rules relating to the data properties of the updated version of the first data offering. In an embodiment, the series of rules may be the same series of rules analyzed in step S404. Based on the analyzing of the series of rules, the data offering management device 302 may determine a current status or state of the updated version of the first data offering. Then, the data offering management 302 may shift the updated version of the first data offering from being in the first administrative state to a second administrative state based on the current status. In some embodiments, the first administrative state may be shifted to the second administrative state when the current status is in an approved and ready status state. In an embodiment, the first data offering may be determined to be in the approved and ready status state when each rule of the series of rules is satisfied and has been approved.

Then, at step S418, the data offering management device 302 may receive a request to publish the updated version of the first data offering. In an embodiment, the request may be transmitted and received by the user interface. The data owner may make the request. Then, the data offering management device 302 may publish the updated version of the first data offering. In an embodiment, the published updated version of the first data offering may be viewable to consumers (e.g., data scientists and/or data analysts). In some embodiments, the updated version of the first data offering may be published within a data marketplace. In an embodiment, the updated version of the first data offering may be publishable when the administrative state is in the second or approved state and the registration state is in the active state.

In an embodiment, the data offering management device 302 utilizes a uniform resource name (URN) notation for data offerings, which may allow upstream automation to leverage the URN to link to existing marketplace content. The data offering management device 302 may utilize revised APIs to introduce a state machine that uses two types of states, an admin state, and a registration state, which are cribbed from the International Organization for Standardization (ISO) standard for metadata registration. The metadata registration state machine may apply logic to all received content, which may allow a data owner's workflow to be presented with a simpler derived state on coarse and fine-grained properties. Additionally, these states may be used to provide visual cues such as differential highlighting. Automation from sources may then create a change notification that is transmitted to the data owners, with embedded links to data offerings and a pre-filtered view of change for approval. Moreover, the APIs may be extended with features toggles and custom endpoints to control what elements are updated through automation and which properties may only be changed in the data owner's workflow.

In an embodiment, the data offering management device 302 may implement automation by using model engineering tools, which incrementally adopt and perform all the model transformation necessary to convert raw metadata to marketplace data offerings. In some embodiments, the model engineering tools may enable the transition to a multi-master state machine without impacting existing upstream data.

In an embodiment, the data offering management device 302 may utilize a plurality of super states (pseudo/derive states that may be shown in the user interface of the data marketplace) for characterizing attributes of the data offerings. The super states may include: 1) onboarding state; 2) active state; and 3) retired state. In some embodiments, the data offering management device 302 may also utilize a plurality of sub states (i.e., registration states) for the registration status of the data offerings. The sub states may include: 1) active state; 2) retired state; 3) hidden/inactive state; and 4) deprecated state. In an embodiment, the data offering management device 302 may additionally utilize a plurality of admin states that are added to different versions of the data offerings. The admin states may include: 1) approved state; 2) pending state; and 3) rejected state. In some embodiments, the data offering management device 302 may be used to manage a plurality of versionable objects including: 1) data offerings; 2) data offering attributes; 3) data services; 4) data service fields; and 5) relationships among the versionable objects.

In an embodiment, the data offering management device 302 may control metadata by defining the properties of the versionable objects in a rule table, similar to a data dictionary for API properties.

In some embodiments, the APIs for the data offering management device 302 may perform a series or plurality of actions. The actions may include: 1) approve addition: “Active (first version+Pending)” changes to “Active (first version+Approved)”; 2) approve change: “Active (next version+Pending)” changes to “Active (next Version+Approved)”, then the previous version is logically deleted; 3) approve removal: “Retired (existing version+Pending)” changes to “Retired (existing version+Approved)”; 4) rejection change: “Active (next version+Pending)” changes to “Logical delete next version (existing version remains)”; 5) rejection removal: “Retired (existing version+Pending)” changes to “Active(existing version+Approved)”; 6) rejection addition: “Active (first version+Pending)”—the first version is logically deleted.

In some embodiments, data offering management device 302 may accept content from multiple platforms and maintain a state machine that allows content to go through transitions gracefully so that the data owner can go through the user interface and see what has changed (e.g., various symbols or markers may indicate changes to the content). Additionally, the data offering management device 302 may allow APIs to maintain various back-end states. In an embodiment, the back-end states may use the registration state and the admin state to derive super states. When a review has been performed and the rules have been satisfied in the user interface, the super states may then be used for a quick activation process. Thus, the data offering management device 302 may facilitate the activation as well as the validation of the data offerings.

In an embodiment, the data offering management device 302 may facilitate the transition for converting content that is pending an approval/update and may maintain the referential integrity of the records. For example, content that is viewable to a consumer may not be pending a change/update. In some embodiments, an API tier may add the referential integrity of the added/updated items to the database. In an embodiment, the changes/updates to the content may come from a plurality of sources (e.g., data distribution platform and/or a data dictionary).

In some embodiments, when a new item, content, and/or data offering is added to the database, the data offering management device 302 may designate it as being in a new state. In this new state, the content may not yet be published or released to the consumer, and only the data owners and/or administrators may see the content. In an embodiment, when the content is selected to be activated, it may go through a stepper that may place the content in a fully active state so that it is published and viewable to a consumer in the data marketplace.

In an example, according to an embodiment, in the operation of addition (e.g., data offering is added to data marketplace) the registration state is active, and the administrative state is pending (i.e., the data offering is not visible to the public). Once the administrative state is moved to the approved state, the data offering may be published and available to consumers. In an embodiment, the state or status is analyzed for a plurality of versionable objects, including the data offering, the child attributes, and the child services to determine if the content is in a fully active state for publication. In an embodiment, each versionable object must have a core set of data properties (e.g., name of the data offering, a description of the what the data offering is for, the line of business, the entitlements, and a data dictionary of attributes).

In some embodiments, the data offering management device 302 may be able to handle and manage multiple data services (e.g., Python, Structured Query Language (SQL), Snowflake, etc.) such that when an update or change is made to the data offering, each item of the data offering may be analyzed and approved/activated across the different data services.

In an embodiment, consumers may be able to view the previous or unedited version of the data offering, while the data owners make changes/updates to a newer or updated version of the data offering that is not viewable to the consumers. In some embodiments, the data offering management device 302 may create notifications in the user interface so that data owners can see the changes and edits that have been made to the data offering. In an embodiment, the user interface may include filters to quickly see what is new and/or updated. In some embodiments, the data owners may use the filters to isolate a change and publish the respective change gracefully, so that the data owner may be in control of what is released to data consumers.

In some embodiments, if the first version of a versioned entity is still pending approval (admin state), any subsequent change may immediately update the first pending version since there may be only one pending approval version of any given URN. In an embodiment, pending approval versions may not need to be stacked, as this would create a sequence of tasks for a data owner, rather than a latest view item.

In an embodiment, business metadata may be maintained by the data offering management device 302. The data offering management device 302 may also receive feedback of titles and descriptions that may differ from directives or annotations in a predetermined schema (e.g., GraphQL). In some embodiments, the initial state machine rules for controlled items may be stored internally, with no requirement to administer these rules in the user interface. The rules may be configured to be driven in the code or database.

In an embodiment, publishing a collection of pending items may operate such that there should be no draft document endpoint, which may prevent publishing until a draft is made active. In an embodiment, the data offering management device 302 may use the root object as the branch version in a pending approval admin state, while all child changes are linked to the new data offering state.

Accordingly, with this technology, an optimized process for accepting and maintaining content in a data platform to improve transitions to updated data content is provided.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for managing data offerings, the method being implemented by at least one processor, the method comprising:
receiving, by the at least one processor via at least one from among a user interface and an automated feed to a system interface, a first data offering, wherein the first data offering is in a first administrative state that is only viewable to a data owner of the first data offering;
analyzing, by the at least one processor, a series of rules relating to at least one data property of the first data offering;
determining, by the at least one processor based on a result of the analyzing of the series of rules, a current status of the first data offering;
shifting, by the at least one processor, the first data offering from being in the first administrative state to a second administrative state based on whether the current status is in a predetermined status;
receiving, by the at least one processor via the user interface, a first request to publish the first data offering; and
publishing, by the at least one processor in response to the first request and the first data offering being in the second administrative state, the first data offering.

2. The method of claim 1, wherein the first data offering includes at least one data set that is accessible via at least one data platform from among a plurality of data platforms.

3. The method of claim 1, wherein the at least one data property includes at least one from among a name of the first data offering, a purpose of the first data offering, a line of business of the first data offering, access rights of the first data offering, and a data dictionary of attributes for the first data offering.

4. The method of claim 1, further comprising:
receiving, by the at least one processor via at least one from among the user interface and the automated feed to the system interface, an updated version of the first data offering, wherein the updated version of the first data offering is in the first administrative state and an active registration state;
analyzing, by the at least one processor, the series of rules relating to the at least one data property of the updated version of the first data offering;
determining, by the at least one processor based on a result of the analyzing of the series of rules for the updated version of the first data offering, a current status of the updated version of the first data offering;
shifting, by the at least one processor, the updated version of the first data offering from being in the first administrative state to the second administrative state based on whether the current status of the updated version of the first data offering is in the predetermined status;
receiving, by the at least one processor via the user interface, a second request to publish the updated version of the first data offering; and
publishing, by the at least one processor in response to the second request and the updated version of the first data offering being in the second administrative state and the active registration state, the updated version of the first data offering.

5. The method of claim 4, wherein the first data offering is in the second administrative state while the updated version of the first data offering is in the first administrative state.

6. The method of claim 4, wherein the user interface comprises a filtering tool that allows a user to filter differences between the first data offering and the updated version of the first data offering.

7. The method of claim 1, wherein the first data offering is maintained by at least one application programming interface (API) that distributes the first data offering using at least one data distribution service from among a plurality of data distribution services.

8. The method of claim 7, wherein the first data offering includes at least one field name that is mappable to a logical data dictionary to be recognizable across the plurality of data distribution services.

9. The method of claim 1, wherein the user interface generates notifications that are transmitted to the data owner when at least one change is made to the first data offering.

10. A computing apparatus for managing data offerings, the computing apparatus comprising:
a processor;
a memory storing instructions; and
a communication interface coupled to each of the processor and the memory,
wherein the processor is configured to:
receive, via at least one from among a user interface and an automated feed to a system interface, a first data offering, wherein the first data offering is in a first administrative state that is only viewable to a data owner of the first data offering;
analyze a series of rules relating to at least one data property of the first data offering;
determine, based on a result of the analysis, a current status of the first data offering;
shift the first data offering from being in the first administrative state to a second administrative state based on whether the current status is in a predetermined status;
receive, via the user interface, a first request to publish the first data offering; and
in response to the first request and the first data offering being in the second administrative state, publish the first data offering.

11. The computing apparatus of claim 10, wherein the first data offering includes at least one data set that is accessible via at least one data platform from among a plurality of data platforms.

12. The computing apparatus of claim 10, wherein the at least one data property includes at least one from among a name of the first data offering, a purpose of the first data offering, a line of business of the first data offering, access rights of the first data offering, and a data dictionary of attributes for the first data offering.

13. The computing apparatus of claim 10, wherein the processor is further configured to:
receive, via at least one from among the user interface and the automated feed to the system interface, an updated version of the first data offering, wherein the updated version of the first data offering is in the first administrative state and an active registration state;
analyze the series of rules relating to the at least one data property of the updated version of the first data offering;
determine, based on a result of the analysis of the series of rules for the updated version of the first data offering, a current status of the updated version of the first data offering;
shift the updated version of the first data offering from being in the first administrative state to the second administrative state based on whether the current status of the updated version of the first data offering is in the predetermined status;
receive, via the user interface, a second request to publish the updated version of the first data offering; and
in response to the second request and the updated version of the first data offering being in the second administrative state and the active registration state, publish the updated version of the first data offering.

14. The computing apparatus of claim 13, wherein the first data offering is in the second administrative state while the updated version of the first data offering is in the first administrative state.

15. The computing apparatus of claim 13, wherein the user interface comprises a filtering tool that allows a user to filter differences between the first data offering and the updated version of the first data offering.

16. The computing apparatus of claim 10, wherein the first data offering is maintained by at least one application programming interface (API) that distributes the first data offering using at least one data distribution service from among a plurality of data distribution services.

17. The computing apparatus of claim 16, wherein the first data offering includes at least one field name that is mappable to a logical data dictionary to be recognizable across the plurality of data distribution services.

18. The computing apparatus of claim 10, wherein the user interface generates notifications that are transmitted to the data owner when at least one change is made to the first data offering.

19. A non-transitory computer readable storage medium storing instructions for managing data offerings, the storage medium comprising executable code which, when executed by a processor, causes the processor to:
receive, via at least one from among a user interface and an automated feed to a system interface, a first data offering, wherein the first data offering is in a first administrative state that is only viewable to a data owner of the first data offering;
analyze a series of rules relating to at least one data property of the first data offering;
determine, based on a result of the analysis, a current status of the first data offering;
shift the first data offering from being in the first administrative state to a second administrative state based on whether the current status is in a predetermined status;
receive, via the user interface, a first request to publish the first data offering; and
in response to the first request and the first data offering being in the second administrative state, publish the first data offering.

20. The computer readable storage medium of claim 19, wherein the first data offering includes at least one data set that is accessible via at least one data platform from among a plurality of data platforms.
